(19) United States
(12) Patent Application Publication
(10) Pub. No.: US 2006/0183513 A1
(43) Pub. Date: Aug. 17, 2006

(54) Audio caller ID for mobile telephone headsets

(76) Inventors: Milan Slamka, Camas, WA (US); Todd Yuzuriha, Vancouver, WA (US)

Correspondence Address: IPSOLON LLP, 111 SW COLUMBIA, SUITE 710, PORTLAND, OR, 97201, US

(21) Appl. No.: 11/223,893

(22) Filed: Sep. 9, 2005

Related U.S. Application Data
(60) Provisional application No. 60/608,662, filed on Sep. 10, 2004.

(51) Int. Cl. H04M 1/64; H04M 1/00

(52) U.S. Cl. 455/575.1; 379/88.03

(57) ABSTRACT

A caller ID feature on the mobile telephone identifies the telephone number of an incoming call and correlates the number with any corresponding voice tag stored in the personal directory. The voice tag associated with the incoming caller is delivered from the telephone to the headset where it is played to provide the user with an audio caller identification. In the absence of a voice tag, voice-synthesized numerals corresponding to the telephone number of the incoming call can be provided to the headset as an audio caller ID.

### TECHNICAL FIELD

The present invention relates to caller identification in mobile telephones and, in particular, to an audio caller identification that provides an audio identification of a caller to a mobile telephone headset.

### BACKGROUND AND SUMMARY OF THE INVENTION

Mobile and other telephones are commonly equipped with electronic personal directories that store the names, numbers and sometimes other reference information for frequently called contacts. Typically, the user creates and administers his personal directory by manually keying in a telephone number and other information for a new entry. Soft keys or touch screen interfaces are often used to dial a phone number selected from a list stored in an electronic personal directory.

As an alternative to soft keys or touch screen interfaces, some mobile telephones include a feature called voice dialing in which a user uses speech recognition to initiate a call. In these telephones the user simply states the name of the party to be called, and the telephone performs speech recognition to correlate the spoken name with a spoken name template or “voice tag” that is stored in the personal directory in association with the telephone number of the party to be called. The telephone then dials the number automatically or first replays the matched voice tag for user confirmation before dialing. The voice tag is a spoken name for the party that had been previously stored in the personal directory by the user. The user may have keyed-in the associated telephone number or may have saved it from a caller ID (CLID) indication stored on the phone.

Voice recognition dialing, or voice dialing, is particularly beneficial when a mobile telephone is used with a user headset, whether the headset is wireless (e.g., a Bluetooth® wireless connection) or is wired to the telephone. When using a headset, the user is commonly engaged in another activity that makes manual accessing of the personal directory inconvenient, impractical or both.

Many telephones include a caller ID feature that identifies the telephone number of an incoming call and correlates the number with any corresponding name in the personal directory. The stored name of the incoming caller is then displayed on the telephone display screen, rather than simply displaying the incoming telephone number. However a user is typically not able to view the display screen when a headset is connected to a telephone, so the user loses the benefit of the caller ID information being correlated with names in the personal directory.

Accordingly, the present invention utilizes voice tags stored in a personal directory to provide a headset user with audio caller identification. In operation, a caller ID feature on the mobile telephone identifies the telephone number of an incoming call and correlates the number with any corresponding voice tag stored in the personal directory. The voice tag associated with the incoming caller is delivered from the telephone to the headset where it is played to provide the user with an audio caller identification. In the absence of a voice tag, voice-synthesized numerals corresponding to the telephone number of the incoming call can be provided to the headset as an audio caller ID. The user may then answer the incoming call knowing the caller identification.

This invention utilizes voice tags that are conventionally stored for the purpose of voice dialing. Using such voice tags for audio caller identification over a telephone headset provides hands-free audio caller identification when a telephone headset is being used.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a block illustrating a mobile telephone in communication with a headset.

FIG. 2 is a flow diagram of an audio caller identification method for a mobile telephone headset.

### DETAILED DESCRIPTION OF THE INVENTION

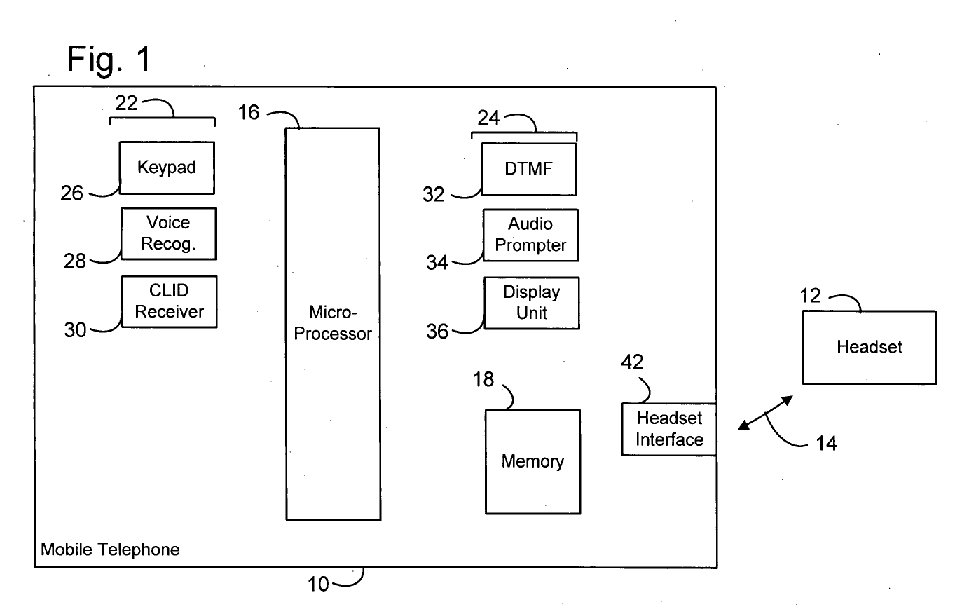

Fig.1 is a block diagram illustrating a mobile telephone 10, such as a cellular mobile telephone, in communication with a headset 12 worn by a user. Headset 12 may be in wired or wireless communication with mobile telephone 10 via a local coupling 14. As one example, local coupling 14 conforms to a standard wireless coupling, such the Bluetooth® standard, or may be a proprietary wireless coupling or a wired coupling.

Mobile telephone 10 includes a microprocessor 16, memory 18, and input devices 22 and output devices 24. The input devices 22 include a keypad 26, a voice recognition unit 28 (including a microphone and speech digitizer, not shown) and a caller ID (CLID) receiver 30. The output devices include a dual tone multi-frequency (DTMF) generator 32, an audio prompter 34 (including an analog speech generator and a connection to the telephone audio speaker or other output), and a liquid crystal display (LCD) unit 36.

A headset interface 42 provides a coupling between mobile telephone 10 and headset 12. Headset interface 42 may use a wireless coupling (e.g., a Bluetooth® or some other wireless connection, whether standardized or proprietary, digital or analog) or may use a wired coupling. With headset 12 connected to mobile telephone 10 at interface 42, voice and other audio are delivered to and from telephone 10 via headset 12, rather than through the microphone and speaker integrated into the telephone 10.

Memory 18 stores program information for operation of mobile telephone 10, as well as information relating to use of the telephone. Telephone use information may include any or all of a dial directory that indicates outgoing calls dialed, an incoming directory indicating incoming calls received based on information received by CLID receiver 30, and a personal directory for the user.

The voice recognition unit 28 cooperates with the microprocessor 16 to produce a voice recognition number that uniquely identifies an utterance made by the user, and a voice tag, or digitized sound clip of the user's voice. The voice recognition number acts as a characteristic representation of at least one identifying characteristic of a rendering associated with the record. In this embodiment the rendering is a voice utterance made by the user. The characteristic representation is used for comparison with other utterances to recognize what the user is saying. The voice tag is used by audio prompter 34 to playback the spoken name associated with a party stored in the personal directory, such as to confirm the speech recognition match in voice dialing. The audio prompter 34 is operable to playback the name of a party as digitized by the voice recognition unit. The CLID receiver 30 receives CLID information during a telephone call and produces name and number information corresponding to the name and telephone number of an incoming caller.

The personal directory stores telephone call contact records that are typically associated with parties the user is most likely to call. Contact records includes at least name, telephone number, and voice tag fields. The name and number fields are used to store as text names and telephone numbers of parties to whom the user may place telephone calls. The voice tag field stores the digitally recorded representation of a user-spoken name of the party, as produced by the voice recognition unit 28. The contents of the voice tag field are the basis for a voice dial command spoken by the user. In addition, the voice tag field may be provided to the audio prompter 34 to playback the spoken name for confirming a voice dial command or the spoken name associated with a record entry.

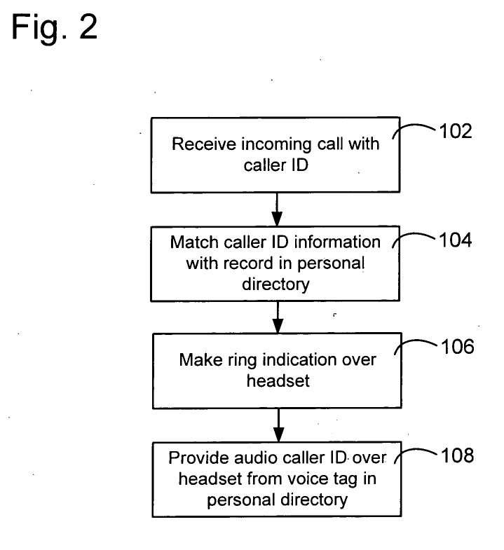

FIG. 2 is a flow diagram of an audio caller identification (Audio-CLID) method 100 implemented on mobile telephone 10 connected to headset 12 according to programming stored in memory 18.

Audio called method 100 utilizes voice tags previously stored in a personal directory for voice dialing as is known in the art. For example, a user may store a voice tag (e.g., a name or nickname) for a person indicated in the personal directory by speaking the name. For subsequent voice dialing, the user again speaks a name that was previously stored as a voice tag. Voice recognition unit 28 identifies the record with the matching voice tag and mobile telephone dials the number associated with the record.

In step 102 a mobile telephone 10 with a connected headset 12 receives an incoming call with a conventional caller ID (“CLID”) indication of the calling telephone number.

In step 104 the incoming conventional CLID information is matched with any entry that is stored in the personal directory and includes that incoming telephone number. The matched information is referred to as the caller's information, which includes at least text identifying information (e.g., a name) and may also include a voice tag representing a user's spoken identifier (e.g., name) for the caller.

In step 106 a ring indication is made over headset 12 to indicate an incoming call. Some mobile telephone users download and store on a mobile telephone 10 an optional ring tone that is played aloud on telephone 10 to indicate an incoming call. In an alternative embodiment, such an optional ring tone can be delivered to headset 12 as a ring indication to indicate an incoming call.

In step 108 text identifying information for the caller is displayed on LCD 36 and an audio caller identification (Audio-CLID) indication is made over headset 12 if the caller's information in the personal directory includes a voice tag. The Audio-CLID indication is a playback of the voice tag stored with the caller's information on telephone 10. In one implementation, the Audio-CLID indication functions also as the ring indication, rather than having a separate ring indication played on headset 12. In one embodiment, in the absence of a voice tag being associated in the personal directory with the number of the incoming call, voice-synthesized numerals corresponding to the telephone number of the incoming call can be provided to the headset as an Audio-CLID.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. In a mobile telephone that provides voice dialing based upon voice tags stored on the telephone, the mobile telephone having a user headset connected thereto, an audio call identifier method, comprising:
receiving a call identifier with an incoming call;
matching the call identifier with a record in a personal directory stored on the mobile telephone; and
if a voice tag is associated with the record, playing the voice tag over the headset as an audio call identifier.

2. The method of claim 1 in which a voice tag is not associated with the record, the method further including playing a voice synthesized indication of a telephone number corresponding to the incoming call.

3. The method of claim 1 in which the voice tag includes a previously-recorded spoken indication for identifying the record in the personal directory.

4. The method of claim 1 in which the audio call identifier is separate from a ring indication that is also delivered to the headset.

5. The method of claim 1 in which the audio call identifier is played without a separate ring indication being played.

6. In a mobile telephone that provides voice dialing based upon voice tags stored on the telephone, the mobile telephone having a user headset connected thereto and a call identifier receiver to receive a call identifier with an incoming call, the improvement comprising:
means to match the call identifier received with an incoming call with a record in a personal directory stored on the mobile telephone; and
means to play the voice tag over the headset as an audio call identifier if a voice tag is associated with the record.

7. The mobile telephone of claim 6 in which a voice tag is not associated with the record, the mobile telephone further including means for playing a voice synthesized indication of a telephone number corresponding to the incoming call.

8. The mobile telephone of claim 6 in which the voice tag includes a previously-recorded spoken indication for identifying the record in the personal directory.

9. The mobile telephone of claim 6 further comprising means to play a ring indication at the headset separate from the audio call identifier.

10. In a computer readable medium of a mobile telephone that provides voice dialing based upon voice tags stored on the telephone, the mobile telephone having a user headset connected thereto, audio call identifier software, comprising:
software for receiving a call identifier with an incoming call;
software for matching the call identifier with a record in a personal directory stored on the mobile telephone; and
software for playing the voice tag over the headset as an audio call identifier, if a voice tag is associated with the record.

11. The medium of claim 10 in which a voice tag is not associated with the record, the method further including playing a voice synthesized indication of a telephone number corresponding to the incoming call.

12. The medium of claim 10 in which the voice tag includes a previously-recorded spoken indication for identifying the record in the personal directory.

13. The medium of claim 10 in which the audio call identifier is separate from a ring indication that is also delivered to the headset.

14. The medium of claim 10 in which the audio call identifier is played without a separate ring indication being played.
